(19) United States
(12) Patent Application Publication
(10) Pub. No.: US 2021/0252691 A1
(43) Pub. Date: Aug. 19, 2021

(54) Cable Tie Holder

(71) Applicant: Nigel Bosworth, Nuneaton (GB)

(72) Inventor: Nigel Bosworth, Nuneaton (GB)

(21) Appl. No.: 17/178,451

(22) Filed: Feb. 18, 2021

(30) Foreign Application Priority Data
Feb. 18, 2020 (GB) 2002222.4

(51) Int. Cl. B25H 3/00; B65D 85/08

(52) U.S. Cl. CPC B25H 3/00; B65D 85/08

(57) ABSTRACT

A storage device for storing cable ties or the like has a plurality of adjacent compartments extending in an axial direction parallel to one another. Retaining members in the form of magnets are provided on side walls of the compartments for releasably holding the device to a supporting structure in use. The compartments each have an open end to allow insertion of the cable tie and a closed end. The compartments have different axial lengths to accommodate different lengths of cable ties. The storage device may be releasably applied to the side of a tool chest or the like.

### CROSS-REFERENCE TO RELATED APPLICATION(S)

This application claims priority to United Kingdom Application Patent Serial No. GB 2002222.4, filed Feb. 18, 2020, the entire disclosure of which is hereby incorporated by reference.

### TECHNICAL FIELD

The present invention relates to storage device for a cable ties and the like.

### BACKGROUND

Cable ties are frequently used in manufacturing or workshop environments. Different lengths of cable ties may be used for different purposes. In a typical arrangement, a plurality of cable ties may be stored in an ad hoc fashion, such as in a tool box or a drawer etc.

The inventor has found that such arrangements can make it difficult to select an appropriately sized cable tie, and results in a generally untidy and inefficient method of storing the cable ties.

The present invention therefore aims to overcome or ameliorate the problems with prior storage solutions for cable ties or the like.

### SUMMARY

According to a first aspect of the invention, there is provided: a storage device for storing cable ties or the like, the device comprising: a plurality of adjacent compartments extending in an axial direction parallel to one another and retaining means for releasably holding the device to supporting structure in use, the compartments comprising an open end to allow insertion of the cable tie and a closed end, where at least two of the compartments comprise different axial lengths.

The open ends of the respective compartments may be provided at the same axial position (i.e. the open ends are aligned).

Adjacent compartments may comprise a tessellating shape. Preferably, the respective walls of adjacent compartments adjoin one another to provide an interface therebetween, and where the walls of the compartments are complementary in shape at the interface.

The retaining means may be arranged to allow releasable mounting of the device to an upright supporting structure. The retaining means may be arranged to hold a side wall of the device immediately adjacent an opposing supporting structure wall. The retaining means may be provided on a side wall of the device.

Preferably, the retaining means comprises one or more magnet.

A plurality, e.g. at least three, retaining means or members may be provided, e.g. being spaced about two orthogonal axes.

The retaining means may be spaced about a common plane.

A single retaining means may be provided on a first compartment and at least two retaining means/members are provided on one or more compartment of greater axial length.

The retaining means may be provided proximal the open and/or closed end of the compartment.

Preferably, the storage device comprises one or more gripping means. Preferably, the gripping means comprise a high friction material (e.g. rubber) pad. Preferably, the gripping means are provided adjacent the retaining means, e.g. one or more magnet. Preferably, the gripping means are annular. Preferably the gripping means at least partially surround the one or more magnet.

The retaining feature and/or gripping means are at least partially embedded and/or mounted flush with the surface of the compartment. The magnet may be recessed with respect to the gripping means. The height of the magnet may be less than or equal to the height of a gripping member. The gripping means may therefore contact the surface/support structure to which the storage device is mounted in use.

The gripping means may be described as a contact member and may be resiliently deformable. The retaining means may be harder or more rigid than the gripping means and may be held adjacent to, e.g. but closely spaced from, support structure in use by the gripping/contact member.

The closed end may be closed via a cap mounted on or within the compartment.

Preferably, the compartments are rectangular.

Preferably, the side walls of the plurality of compartments collectively define a substantially flat surface.

Preferably, at least three compartments are provided, the compartments provided in a planar arrangement.

The storage device may be for storing cable ties of different lengths, e.g. in the different compartments.

### BRIEF DESCRIPTION OF THE DRAWINGS

Practicable examples of the invention are described in further detail below with reference to the accompanying drawings, of which:

FIG. 1 shows three-dimensional view of a storage device for cable ties;

FIG. 2 shows a front view of the storage device attached to a tool chest; and

FIG. 3 shows a side of the storage device attached to the tool chest.

### DETAILED DESCRIPTION

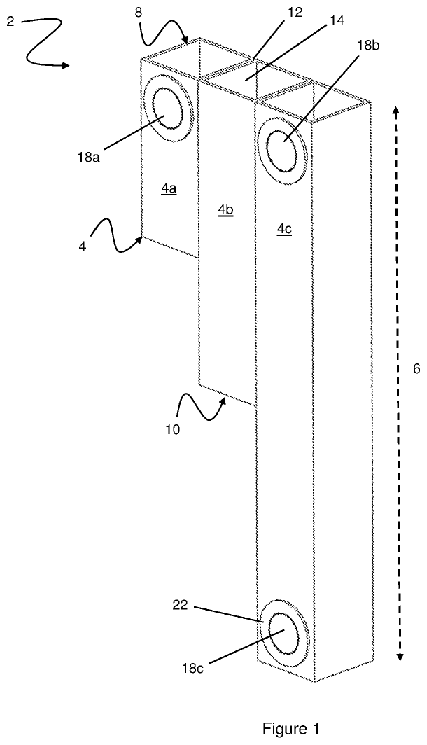

FIG. 1 shows a holder 2 for a holding and storing cable ties or the like. The holder 2 comprises a plurality of compartments 4 configured to store the cable ties.

The compartments 4 extend in an axial direction 6, e.g. being elongate in form. The compartments 4 are parallel (i.e. each compartment extends in the axial direction).

The compartments 4 comprises an open end 8 to allow insertion of the cable ties and a closed end 10 configured to support the ties in the compartment 4. The ties are typically loosely held in the compartment in use, i.e. with the open end of the compartments facing upwardly so that cable ties remain therein under gravity.

The compartments 4 are fixed to one another, for example, using welding. Alternatively, the compartments 4 are fixed using fasteners, rivets or other conventional techniques.

The compartments are arranged in a side-by-side arrangement, e.g. with a face of one compartment lying against an opposing face of the adjacent compartment. One or more central compartment may be sandwiched between adjacent compartments on each side thereof.

The compartments 4 comprise a metallic material (e.g. steel).

The compartments are hollow. The compartments 4 may be formed from a folded sheet or may be cut from a tubular length of a hollow member, e.g. being of square/rectangular section. Other sectional shapes may be used, although a flat surface is preferred for joining to the adjacent compartment.

The closed ends 10 may comprise a cap (not shown) configured to seal the end of the compartment. The cap may be removable. The cap may comprise a polymeric material. The cap provides a convenient means to seal the compartments 4.

The holder 2 may be coated, painted or otherwise treated, for example, using powder coating.

The respective compartments are of differing lengths. A first compartment 4a extends in the axial direction by a first distance; a second compartment 4b extends in the axial direction by a second, greater distance; and a third compartment 4c extends in the axial direction by a third, even greater, distance. This allows the accommodation of a plurality of differing length cable ties in the holder 2. The compartments are provided in length sequence in this example.

The ratio of the lengths of the first compartment 4a:second compartment 4b:third compartment 4c may be 1:1.5-1.9:2.7-3.7, preferably 1:1.7:3.2. For example, the length of the second compartment 4b may be greater than 1.5 times the length of the first compartment 4a. The length of the third compartment 4c may be greater than 2.5 times the length of the first compartment 4a.

The open ends 8 of the respective compartments are aligned (i.e. are provided at the same axial position and/or are co-planar). The closed ends 10 are therefore provided at differing axial/length positions (i.e. they are staggered). This ensures that when differing length cable ties are accommodated in the respective compartments, the ends of the cable ties will be at substantially the same axial position, and therefore easy to access.

The compartments 4 are arranged in an ascending/descending length order (e.g. shortest to longest).

The walls of adjacent compartments adjoin one another to define an interface 12 therebetween. The interface 12 is tessellating (i.e. the sides/walls 14 of adjoining compartments 4 are complementary in shape). This provides a space efficient configuration, allowing the holder 2 to store a greater number of cable ties in a given footprint. In the present embodiment, the tessellating interface 12 is substantially planar. However, it can be appreciated that the interface may be any shape, such as arcuate and/or polygonal.

The compartments 4 are rectangular/square. The sides 14 of the rectangle therefore provide the tessellating interface 12. However, it can be appreciated that the compartments may be any tessellating shape, such as triangular, trapezoidal, hexagonal, circular/crescent and/or other arcuate or polygonal shapes.

The holder 2 is substantially planer (i.e. the compartments 4 are spaced about a single plane). The non-adjoining side walls of the compartments thus collectively define a substantially flat surface.

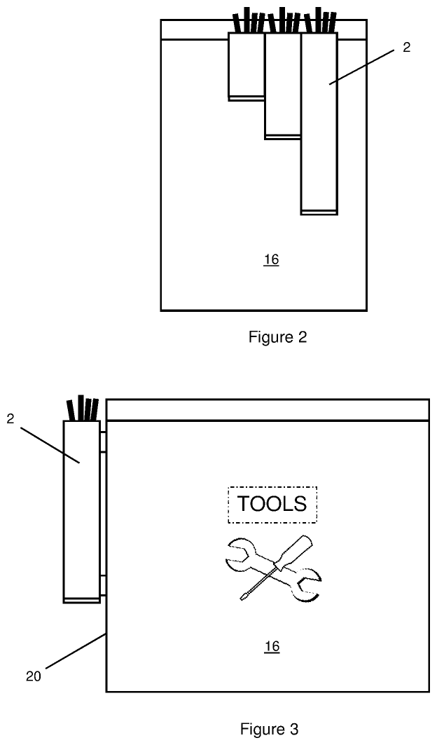

FIGS. 2 and 3 shows the holder 2 mounted to tool chest 16.

The holder 2 comprises a retaining feature to retain the holder 2 onto the tool chest 16. In the present embodiment, the retaining feature comprises a plurality of magnets 18 (seen most clearly in FIG. 1).

The adjacent compartments 4a, 4b, 4c collectively define a side wall of the holder, i.e. a wall defining the width of the holder 2, e.g. as distinct from the holder end walls or the top/bottom surfaces of the holder.

The magnets 18 are provided on the side walls 14 of the compartments 4, e.g. being exposed. The magnets 18 are therefore provided on the side wall of the holder 2 (i.e. not provided on or planar with the open/closed ends of the compartments). This allows the compartments to be held in an upright position when attached to a vertical side wall 20 of a tool chest 16. Additionally, the holder 2 is substantially flat against the tool chest 16, thereby providing a compact configuration.

A first magnet 18a is provided on the first compartment 4a. A second magnet 18b and a third magnet 18c are provided on the third compartment 4c. The second and third magnet are axially spaced along the third compartment 4c, i.e. in a length direction. The first 18a and second 18b/third 18c magnet are laterally spaced on the side wall of the holder.

The magnet placement provides a secure attachment as the magnets 18 are spaced about 2 orthogonal directions, thus preventing easy lifting of the holder away from the attached surface. The magnets 18 are spaced about a common plane.

The magnets 18 may be provided adjacent/proximal an open end 8 and/or closed end 10 of any or any combination of the compartments 4a, 4b, 4c. The magnets are maximally spaced, e.g. towards the corners of the side wall, in the example shown.

In some embodiments, the holder 2 may comprise additional magnets on the opposing side of the holder 2, such that either side of the holder may be attached to a tool chest 16 etc. The additional magnets may be provided in the same fashion as described above.

The magnets 18 may be recessed or mounted within the wall of the compartment 4. The magnet 18 may therefore be substantially flush with the wall of the compartment 4. In other embodiments, the magnets 18 may be mounted onto the wall of the compartment, such that it protrudes therefrom.

A grip member 22 is provided on the holder to prevent the holder 22 slipping whilst mounted on the tool chest 16. The grip member 22 may comprise a rubber and/or other high-friction and/or resiliently deformable material pad. The grip member 22 is provided adjacent the magnet 16 (e.g. surrounds the magnet 16), thus increasing the frictional force provided by the grip member 22 since it is biased into contact with the tool chest 16 by the magnetic attraction. The holder 2 is thus retained using both the grip member and the magnet 16.

The grip member 22 is substantially annular in this example to closely surround the magnet. However grip members of alternative shape could be considered, e.g. for different magnet shapes.

The height of the grip member 22 is slightly greater than that of the magnet 16 therein. This ensures the grip member makes initial contact with the tool chest or other surface on which the holder is provided. The magnet itself may lightly touch the supporting surface in use or may be held closely spaced, i.e. immediately adjacent by not touching, the surface in use.

In the present embodiment, three compartments 4 are provided, however, it can be appreciated that any number of compartments 4 may be provided depending on the specific application. Where three or more compartments 4 are present, two or more of the compartments may comprise the same length, thereby providing two or more compartments for storing a cable tie of a given length.

Although the holder 2 is shown mounted to a tool chest in the present embodiment, it can be appreciated that the holder may be mounted to any suitable surface as required, for example, a tool box, a workbench, a shelf/rack or metallic wall etc.

The present embodiment discloses a holder for cable ties, however, the holder may be used for similar items of differing lengths, for example, fasteners, stationery, tools etc.

The present invention provides a convenient, compact and simple arrangement for holding cable ties and the like, so as to remove the need to repeatedly open/close a tool chest or else search to find different lengths of cable tie.

The holder segregates different lengths of cable tie and presents each of the cable ties at the same height for the user.

The magnetic retaining feature allows the holder to be selectively mounted to any suitable surface, therefore providing a flexible and universal solution. The holder may be transported to different locations or work environments, whilst maintaining segregation of the cable ties.

The spatial arrangement of the magnet and the gripping members provide a secure attachment to a tool chest or the like.

What is claimed is:

1. A storage device for storing cable ties or the like, the device comprising:
a plurality of adjacent compartments extending in an axial direction parallel to one another, said compartments having a side wall and the storage device having a retaining member on the side wall for releasably holding the storage device to a supporting structure in use,
the compartments comprising an open end to allow insertion of the cable tie and a closed end, said open and closed ends being spaced by the side wall,
wherein at least two of the compartments comprise different axial lengths.

2. A storage device according to claim 1, where the open ends of the respective compartments are provided at the same axial position.

3. A storage device according to claim 1, where adjacent compartments comprise a tessellating shape.

4. A storage device according to claim 3, where the adjacent compartments adjoin one another to provide an interface therebetween, and where the compartments are complementary in shape at the interface.

5. A storage device according to claim 1, where the retaining member is arranged to allow releasable mounting of the device to an upright supporting structure.

6. A storage device according to claim 1, where the retaining member is arranged to hold the side wall immediately adjacent an opposing supporting structure wall.

7. A storage device according to claim 1, where the retaining member comprises a magnet.

8. A storage device according to claim 1, comprising a plurality of the retaining members.

9. A storage device according to claim 8, where at least three retaining members are provided, the retaining members being spaced about two orthogonal axes.

10. A storage device according to claim 8, where the retaining members are spaced about a common plane on different compartments.

11. A storage device according to claim 8, where a single retaining member is provided on a first compartment and at least two retaining members are provided on one or more compartment of greater axial length than the firs compartment.

12. A storage device according to claim 1, where the retaining member is provided proximal the open and/or closed end of the compartment.

13. A storage device according to claim 1, where the storage device comprises one or more grip or contact member.

14. A storage device according to claim 13, where the grip member comprises a resiliently deformable material in the form of a pad.

15. A storage device according to claim 13, where the grip member is provided adjacent the retaining member.

16. A storage device according to claim 13, where the grip member is annular and at least partially surround the retaining member.

17. A storage device according to claim 13, where the retaining member and/or grip member is at least partially embedded and/or mounted flush with the surface of the side wall of the compartment.

18. A storage device according to claim 13, where the grip member protrudes from the side wall of the compartment to a greater height than the retaining member such that the retaining member is recessed with respect to the grip member.

19. A storage device according to claim 1, where the closed end is closed via a cap mounted on or within the compartment.

20. A storage device according to claim 1, where the compartments are rectangular.

21. A storage device according to claim 1, where the side walls of the plurality of compartments collectively define a substantially flat side surface of the storage device.

22. A storage device according to claim 1, where at least three compartments are provided, the compartments being provided in a planar arrangement.
